(19) United States
(12) Patent Application Publication
(10) Pub. No.: US 2008/0269069 A1
(43) Pub. Date: Oct. 30, 2008

(54) Method of Performing a Microarray Assay

(75) Inventors: Johannes Bacher, Leonberg (DE); Andreas Boos, Bondorf (DE); Gerd Luedke, Holzgerlingen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,074

(22) PCT Filed: Dec. 11, 2006
(86) PCT No.: PCT/IB2006/054737

§ 371 Date: Jun. 19, 2008

(30) Foreign Application Priority Data
Dec. 21, 2005 (EP) 05112548.2

(51) Int. Cl. C40B 30/10

(52) U.S. Cl. 506/12

(57) ABSTRACT

Disclosed is a method for performing a microarray assay on one or more sample fluid(s), said fluids comprising target biological compounds. The method comprises the step of tagging said target biological compounds with labels. The following step comprises contacting said sample fluid(s) with a substrate and detecting the presence of said labels at the surface of said substrate. The method is suitable for the simultaneous analysis, in one microarray, of one or more types of target biological compounds, in one or more sample fluid(s). To this end each of said types of biological compounds is tagged with a different label so that target biological compounds belonging to different sample fluids have different labels. Said different labels are discriminable upon detection at the surface of said substrate. Also disclosed is the use of a polymer substrate in a method for performing a microarray assay.

The present invention relates to the quantitative and/or qualitative analysis or determination of individual biological compounds in biological fluids. In particular, the invention relates to an improved, inexpensive and efficient method for performing a microarray assay. More specifically, the invention relates to a method for performing the differential tagging of several types of biological compounds originating from one or more samples within a microarray assay.

The presence and concentration of multiple specific target biological compounds such as, but not limited to, DNA, RNA or proteins, in a biological sample containing one or more other molecules can be determined during a single experiment by using the so-called microarray technique. In this technique, a set of specific probe molecules, each of which being chosen in order to interact specifically with one particular target, are immobilized at specific locations of a solid surface. On the other hand, the target biological compounds are labeled by a detectable molecule (e.g. a fluorophore or a magnetic bead). By contacting said solid surface with the biological sample, the target biological compounds will be fixed at the locations corresponding to their specific probes. The detection of the target biological compounds and the assessment of their concentration in the biological sample will then be operated respectively via the localization and the measurement of the intensity of the signals produced by the detectable molecules bound to the target.

Such a method is disclosed for instance in WO03/004162 wherein a surface is arrayed with 3 distinct oligonucleotide DNA probes and is hybridized to a sample pool of 3 distinct complementary DNA targets. The targets are modified with a fluorescent label (fluorescein isothiocyanate) to permit direct detection on the surface. As the sample is contacting the surface, specific targets are captured from solution by the probes onto the surface and detection is performed by means of an epi-fluorescence microscope. WO03/004162 discloses several improvements to the general method described above, such as the use of a porous substrate in order to permit the sample to contact the probes by flowing through said substrate, optionally repeatedly via the use of a pumping system. This approach has the advantage to considerably fasten hybridization. An other improvement is the use of a thermal chamber for controlling the temperature of the sample. Hybridization being a temperature-dependent phenomenon, temperature control provides advantages, e.g. for nucleic acid analyses.

However, this prior art method does not provide a way to simultaneously perform a microarray technique on more than one sample (e.g. blood of healthy vs. diseased patients) or on two different types of biological compounds (e.g. RNA and DNA) present in one biological sample in a single experiment. These limitations result in considerable increase in the time needed, and consequently the cost involved, in the quantitative and/or qualitative analysis or determination of individual biological compounds in several biological fluids and/or belonging to different types of biological compounds.

There is therefore a need in the art for an improved, less time-consuming and more efficient, method to perform a microarray technique on more than one biological sample simultaneously, or on two or more different types of biological compounds present in one biological sample within a single experiment.

As used herein, and unless stated otherwise, the term “type ”, when applied to a target biological compound, designates a group of compounds which are related by their molecular structure. Exemplary types of target biological compounds involved in the present invention include, but are not limited to, DNA biological compounds, RNA biological compounds, polypeptides, enzymes, proteins, antibodies and the like.

As used herein, and unless stated otherwise, the term “microarray assay” designates an assay wherein a sample, preferably a biological fluid sample (optionally containing minor amounts of solid or colloid particles suspended therein), containing target biological compounds is contacted with (e.g. passed through) a substrate (e.g. a membrane), containing a multiplicity of discrete and isolated regions across a surface thereof, each of said regions having one kind of probe applied thereto (e.g. by spotting), and each of said one kind of probebeing chosen for its ability to bind with some specificity, preferably a specificity under stringent conditions, preferably a specificity under highly stringent conditions, to a maximum of one target biological compound per type of biological compound. As is well known to the skilled person, the stringency of binding conditions involve a series of parameters such as temperature, ionic concentration and pH.

As used herein, and unless stated otherwise, the term <<target >> designates a molecular compound fixed as goal or point of analysis. It includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), cellular organelles, intact cells, and the likes.

As used herein, and unless stated otherwise, the term <<probe >> designates an agent, immobilized onto the substrate's surface or/and into the substrate, able to interact specifically with a <<target >> that is part of the sample and used to detect the presence of said specific target. It includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), cellular organelles, intact cells, and the likes.

As used herein, and unless stated otherwise, the term <<label >> designates an agent, readily detected so as to enable the detection of its physical distribution or/and the intensity of the signal it delivers, such as but not limited to luminescent molecules (e.g. fluorescent agent, phosphorescent agent, chemiluminescent agents, bioluminescent agents and the likes), coloured molecules, molecules producing colours upon reaction, enzymes, magnetic beads, radioisotopes, specifically bondable ligands, microbubbles detectable by sonic resonance and the likes.

As used herein, and unless stated otherwise, the term <<tag >> designates the action to incorporate a label to a probe.

Broadly speaking, this invention relates in a first aspect to a method for simultaneously performing the differential tagging of several types of biological compounds originating from one or more samples within a single microarray assay. This invention also relates in a second aspect to the use of a substrate such as, but not limited to, an inorganic wafer or an organic membrane, in a method including the differential tagging of several types of biological compounds originating from one or more samples within a single microarray assay.

In its broader acceptation, the present invention relates to a method for performing a microarray assay on one or more sample fluid(s) comprising target biological compounds, said method comprising tagging said target biological compounds with labels, contacting said sample fluid(s) with a substrate and detecting the presence of said labels at the surface of said substrate, wherein said method is suitable for the simultaneous analysis, in one microarray, of one or more types of target biological compounds, in one or more sample fluid(s), and wherein:
(i) each of said types of biological compounds is tagged with a different label so that target biological compounds belonging to different sample fluids have different labels,
(ii) at least one of the number of types of target biological compounds and the number of sample fluids is at least 2, and
(iii) said different labels are discriminable upon detection at the surface of said substrate.

An important feature of the present invention is that at least two different labels are simultaneously used during a single performance of the method. Another important feature of the present invention is that these at least two different labels should be discriminable upon detection by a standard label detection method. This feature permits to achieve a significant gain of time in the analytical method by either:
simultaneously measuring analytes from different samples (e.g. analysing in a single experiment a blood sample and a sputum sample for their DNA content), or
simultaneously measuring differential expression of analytes from multiple samples (e.g. analysing for their DNA content, in a single performance of the method, both a blood sample originating from a healthy patient and a blood sample originating from a diseased patient), e.g. for comparison purposes, or
simultaneously measuring or analysing different types of target biological compounds from the same sample (e.g. analysing in a single performance of the method a blood sample both for its DNA content and for its RNA content), or
simultaneously measuring different type of target biological compounds from different samples (e.g. analysing in a single experiment both a blood sample and a sputum sample for their DNA content and their RNA content).

The method of the present invention is especially useful when the target biological compounds present in the sample(s), preferably the fluid sample(s), to be analyzed are molecules such as, but not limited to, the following:
oligopeptides having from about 5 amino-acid units to 50 amino-acid units,
polypeptides having more than 50 amino-acid units,
proteins, including enzymes,
oligo- and polynucleotides,
antibodies, or fragments thereof,
RNA, and
DNA.

For certain target biological compounds, a denaturation step may be beneficial, e.g. double stranded DNA can be separated into single strands in order to allow specific binding of the single strands to the capture probes spotted on the membrane. Such a denaturation step can be implemented in a convenient manner for instance by heating up either the substrate (wafer or membrane) or the sample, or both. When the sample is heated in such a denaturation step, an optional cooling step may be performed in order to keep the strands separated.

The labels used to tag said target biological compounds in a first step of the method, and ultimately permit their detection in a last step of the method, can be of luminescent (fluorescent, phosphorescent, chemioluminescent), radioactive, enzymatic, calorimetric, sonic (e.g. resonance of micro-bubbles) or magnetic nature. A specifically bindable ligand can be used in place of a label. In this last case, the ligand will be bound in a next step with a compatible label bearing agent.

Suitable fluorescent or phosphorescent labels are for instance but are not limitated to fluoresceins, Cy3, Cy5 and the likes.

Suitable chemioluminescent labels are for instance but are not limitated to luminol, cyalume and the likes.

Suitable radioactive labels are for instance but are not limitated to isotopes like ¹²⁵I or ³²P.

Suitable enzymatic labels are for instance but are not limitated to horseradish peroxidase, beta-galactosidase, luciferase, alkaline phosphatase and the likes.

Suitable calorimetric labels are for instance but are not limited to colloidal gold and the likes.

Suitable sonic labels are for instance but are not limitated to microbubbles and the likes.

Suitable magnetic beads are for instance but are not limitated to Dynabeads and the likes.

Each target biological compound can be tagged with up to about 300 identical labels (during an eventual PCR amplification step for instance) in order to increase sensibility. As an optional step, unbound labels not incorporated into the target biological compound and still present in the sample fluid may be removed from the sample fluid by means of chemical and/or physical treatments (e.g. chemical PCR purification, dialysis or reverse osmosis) in order to reduce the background signal during later measurements.

The sample fluid can be from industrial or natural origin. Examples of sample fluids suitable for performing the method of this invention may be, but are not limited to, body fluids such as sputum, blood, urine, saliva, faeces or plasma from any animal, including mammals (especially human beings), birds and fish. Other non-limiting examples include fluids containing biological material from plants, nematodes, bacteria and the like. The only requirement for a suitable performance of the method of this invention is that said biological material is present in a substantially fluid, preferably liquid form, for instance in solution in a suitable dissolution medium. The volume of the sample fluid to be used in the method of this invention can take any value between about 5 μl and 1 ml, preferably between about 50 μl and 400 μl.

In many cases, it is desirable to incorporate a buffer (e. g. a hybridization buffer) either directly into the sample fluid to be analyzed or as an integral part of the detection unit (e.g. added as a fluid or in lyophilized form either above or below the substrate), thus eliminating the need for a separate hybridization buffer storage area.

The substrate onto which the probes are applied (e.g. spotted) is not a limiting feature of this invention and therefore can be made of any material already described in the art as a suitable substrate for microarray assays. Non-limitative examples of such materials typically include
organic polymers such as polyamide homopolymers or copolymers (e.g. nylon), thermoplastic fluorinated polymers (e.g. PVDF), polyvinylhalides, polysulfones, cellulosic materials such as nitrocellulose or cellulose acetate, polyolefins or polyacrylamides and
inorganic materials such as glass, quartz, silica, other silicon-containing ceramic materials, metal oxide materials such as aluminium oxides, and the like.

These materials can be activated or not. If activated, the activation can be performed by a chemical or a physical treatment. Suitable means of activation include, but are not limited to, plasma, corona, UV or flame treatment, and chemical modification. Depending upon the kind of material, especially the kind of organic polymer material, suitable chemical modifications include, but are not limited to, introduction of quaternary ammonium ions (e.g. into polyamides), solvolysis (e.g. hydrolysis), derivatization of amide groups to amidine groups (e.g. in polyamides), hydroxylation, carboxylation or silylation. A non-limitative example of a substrate material not requiring activation for a suitable performance of the method of the invention is nylon (polyamide homopolymers) especially when used for DNA or RNA analysis since it has an intrinsic affinity for oligo- and polynucleotides.

The substrate to be used in the method of the invention can be either porous or non-porous. If the substrate is non-porous, hybridization may simply be performed by contacting said non-porous substrate with the sample fluid, preferably with some agitation and long enough for the hybridization to take place (e.g. for a period of time ranging from about 4 to 20 hours).

If the substrate is porous, hybridization is preferably performed by passing said sample fluid through said porous substrate. This can be done for instance by pumping the sample fluid one or more times in one or both directions through the porous substrate. This can also be effected by moving the porous substrate itself one or more times through the sample fluid in order to force the sample fluid through the pores of said porous substrate. For instance, the substrate can be moved relatively to a chamber containing the sample fluid in a direction perpendicular to the plane of said substrate.

If the substrate is porous, it may include a network having a plurality of pores, openings and/or channels of various geometries and dimensions. The substrate may be nanoporous or microporous, i.e. the average size of the pores, openings and/or channels may suitably be comprised between 0.05 μm and 10.0 μm, preferentially between 0.1 μm and 1.0 μm, more preferentially between 0.3 and 0.6 μm. The pore size distribution may be substantially uniform or it may have a polydispersity from about 1.1 to about 4.0, depending upon the manufacturing technology of said substrate. The surface corresponding to the pores, openings or channels may represent between about 1 and 99%, preferably from about 10% to 90%, and more preferably from about 20% to 80%, of the total surface of either the upper surface or the lower surface of the porous substrate.

The thickness of the substrate, e.g. the membrane, is not a limiting feature of this invention and it can vary from about 10 μm to 1 mm, preferably from 50 μm to 400 μm, more preferably from 70 μm to 200 μm. The shape of the substrate, e.g. the membrane, is not a limiting feature of the present invention. It may be circular, e.g. with a diameter ranging between about 3 and 15 mm, but the method of the present invention can also be applied to any other substrate shape and/or size.

The probes used for the present invention should be suitably chosen for their affinity to the target biological compounds or their affinity to relevant modifications of said target biological compounds. For example, if the target biological compounds are DNA, the probes can be, but are not limited to, synthetic oligonucleotides, analogues thereof, or specific antibodies. A non-limiting example of a suitable modification of a target biological compound is a biotin substituted target biological compound, in which case the probe may bear an avidin functionality.

In order to more easily support subsequent detection and identification, one or more additional spots (e.g. for intensity calibration and/or position detection) can be spotted as well onto the surface of the substrate.

Following spotting, the probes become immobilized onto the surface of the substrate, either spontaneously due to the substrate (e.g. membrane) inherent or acquired (e.g. via activation) properties, or through an additional physical treatment step (such as, but not limited to, cross-linking, e.g. through drying, heating or through exposure to a light source).

In order to improve the shelf-live of the substrate (e.g. membrane) and the probes attached thereon, drying the membrane when the membrane is not in use may be helpful. The membrane is thereafter rehydrated in contact with the sample fluid.

Once the probes are applied (e.g. via inkjet spotting) onto a surface of the substrate, the addition of an effective amount of a blocking agent in order to inactivate the non-spotted areas of the substrate may be helpful to prevent unspecific binding of target biological compounds or unbound labels to unspotted areas (that would lead to unwanted background signal) and to therefore increase to signal/noise ratio. Examples of suitable blocking substances or agents include, but are not limited to, salmon sperm, skim milk, or polyanions in general.

In the case of a porous substrate, quantitatively measuring the presence of labels after a predetermined number of pumping cycles, e.g. after each pumping cycle, or after a predetermined number of substrate moving cycles, e.g. after each substrate moving cycle, may be useful. The results of such quantitative measurements, in combination with the knowledge of the actual substrate and/or sample fluid temperature, permits to determine the kinetic properties of the target biological compounds. Heating the sample fluid to a defined temperature allows, through imparting more stringent binding conditions, a more precise control of the binding properties, especially binding specificity. This heating step can also be achieved by heating either the membrane or the sample fluid or both. After the desired temperature has been reached, the sample fluid is then contacted with substrate.

Sensitivity of the method and/or binding specificity can be increased by suitable means such as, but not limited to:
using appropriate temperature profiles (e.g. a series of one or more heating steps optionally with adequate equilibration times between consecutive heating steps),
adapting the number of substrate moving cycles, and
signal post-processing of the measured label signals (e.g. image processing of fluorescence image) for a measurement series, and
determining the temperatures at which the captured target biological compounds bind optimally or separate again.

For example, when increasing the temperature, a sharp decrease of the measured signal will indicate that the separation (melting) temperature of a given capture probe-target biological compound complex has been reached. This property can be used to distinguish between specific and unspecific binding. To even further improve specificity, the measurement cycle can the be continued after exceeding the melting temperature threshold, this time with continuously decreasing temperatures in order to confirm that re-binding of the target biological compounds occurs again below appropriate specific melting temperature.

An optional final step of the method consists then in removing residual sample fluid from the detection chamber in order to further decrease the background signal due to unbound labels and/or labeled biological compounds.

The detection chamber geometry is preferably designed in such a way that unbound labels and/or biological compounds are shielded from the detection system during measurement, e.g. (in the case of labels being luminescent molecules) through obstruction of the optical path for the light emitted from the sample fluid below the membrane or by moving the membrane close to the optically transparent window and thereby chasing away the supernatant. The background signal can be further reduced by whipping the supernatant by a built-in whiper. The removal of the sample fluid as well as the design of the detection chamber geometry ensure that the substrate surface facing the detection system as well as the opposite side of the membrane have a minimal amount of sample fluid as surface layers. This reduces the background signal from unbound labels and/or unbound labeled biological compounds.

After a suitable contact time of the substrate with the sample fluid, e.g. after a suitable number of sample pumping cycles through a porous substrate or a suitable number of membrane moving cycles, the labels of the target biological compounds bound to the probes are detected and measured. Additionally, the labels may also be measured during the movement of the membrane.

The physical location, the nature and the intensity of each signal observed permits to identify which target biological compound has been captured, to identify from which sample this target biological compound originates and/or to which type(s) of biological compound it belongs and to assess its concentration.

Analysis of the substrate in the final step of the method of the invention may be performed via an optical set-up comprising an epi-fluorescence microscope and a CCD (charged coupled device) camera or any other kind of camera. This optical set-up preferably comprises a (preferably UV) light source capable of exciting the labels at their respective excitation wavelength, in the case of fluorescent or phosphorescent labels.

The detection of chemioluminescent labels is for instance performed by adding an appropriate reactant to the label and observing its fluorescence via the use of a microscope.

The detection of radioactive labels is for instance performed by the placement of medical X-ray film directly against the substrate which develops as it is exposed to the label and creates dark regions which correspond to the emplacement of the probes of interest.

The detection of enzymatic labels is for instance performed by adding an appropriate substrate to the label and observing the result of the reaction (e.g. colour change) catalyzed by the enzyme.

The detection of colorimetric labels is for instance performed by adding an appropriate reactant to the label and observing the resulting appearance or change of colour.

The detection of sonic microbubble labels is for instance performed by exposing said labels to sound waves of particular frequencies and recording the resulting resonance.

The detection of magnetic beads is for instance performed by magnetic sensor(s).

The method of the present invention has been described herein above by reference to a significant number of parameters, each of them including the possible selection of preferred, or even more preferred, values or embodiments. It should be understood that, unless explained otherwise with respect to certain combination of parameters, each preferred range or embodiment for one such parameter may be combined at will with each preferred range or embodiment for one or more other parameters.

This invention will now be described with respect to certain working embodiments explained in the following examples and with reference to the appended figures. These examples however are merely illustrative of the invention and should not be construed as limiting the invention in any way.

### EXAMPLE 1

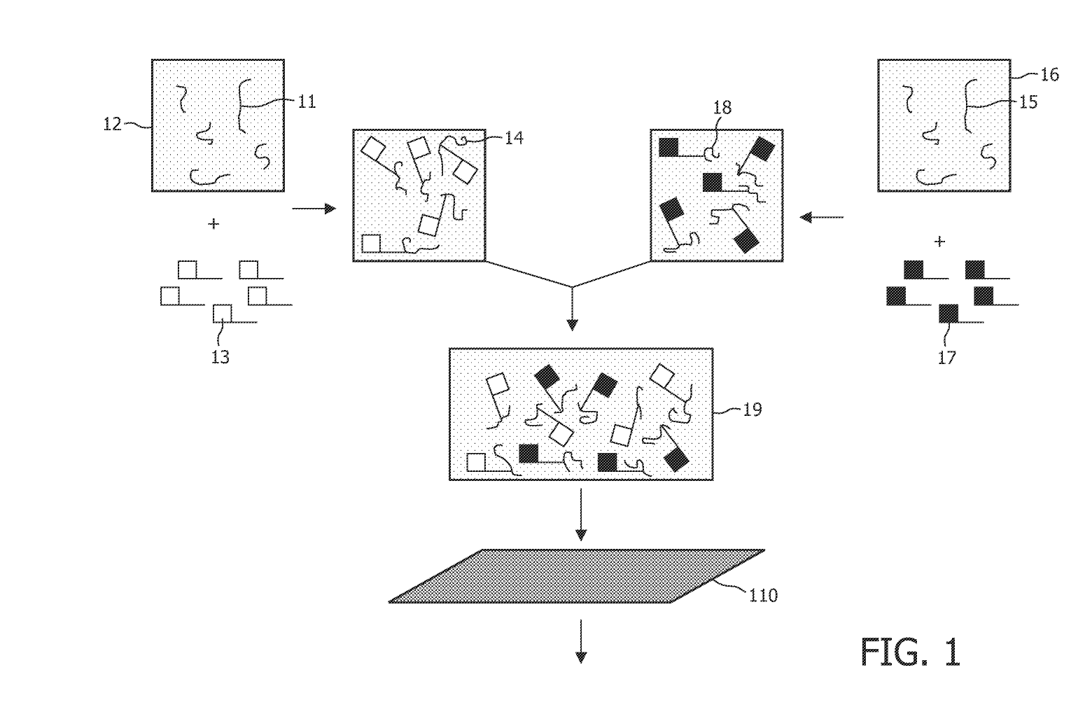

A first working embodiment of the present invention is described in FIG. 1. In the left side of FIG. 1, target DNA molecules (11) present in a first fluid sample (12) are tagged with a first kind of label (13) in order to give tagged target DNA molecules (14). In the right side of FIG. 1, target DNA molecules (15) present in a second fluid sample (16) are tagged with a second kind of label (17) in order to give tagged target DNA molecules (18). In the center of FIG. 1, both samples are mixed together to form a mixture (19), which is then forced through a substrate (110).

### EXAMPLE 2

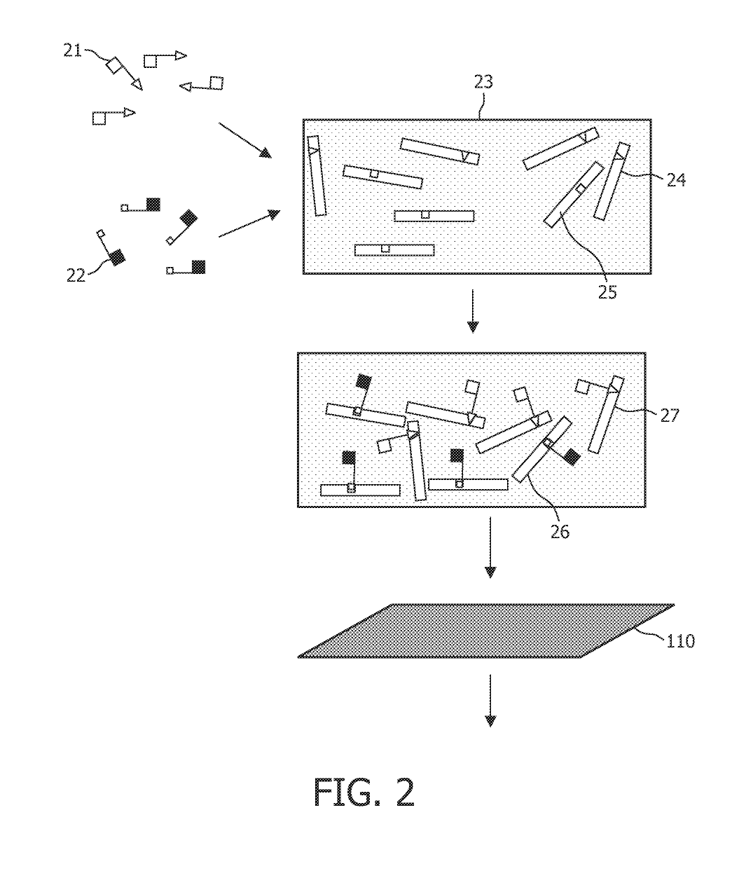

A second working embodiment of the present invention is described in FIG. 2. In the upper part of FIG. 2, two different kinds of labels (21) and (22) are incorporated with two different types of target molecules (RNA molecules (24) and DNA molecules (25)) present in a sample (23) to give tagged target RNA molecules (27) and tagged target DNA molecules (26) in said sample. Said sample is then forced through substrate (110).

1. A method for performing a microarray assay on one or more sample fluid(s) comprising target biological compounds, said method comprising tagging said target biological compounds with labels, contacting said sample fluid(s) with a substrate and detecting the presence of said labels at the surface of said substrate, wherein said method is suitable for the simultaneous analysis, in one microarray, of one or more types of target biological compounds, in one or more sample fluid(s), and wherein:
(i) each of said types of biological compounds is tagged with a different label so that target biological compounds belonging to different sample fluids have different labels,
(ii) at least one of the number of types of target biological compounds and the number of sample fluids is at least 2, and
(iii) said different labels are discriminable upon detection at the surface of said substrate.

2. A method according to claim 1, wherein said sample fluid(s) is (are) passed through said substrate.

3. A method according to claim 1, wherein said substrate is a porous substrate.

4. A method according to claim 1, wherein said substrate comprises a polymer.

5. A method according to claim 1, wherein comprises a polyamide homopolymer or copolymer.

6. A method according to claim 5, wherein said polyamide homopolymer or copolymer is modified by introduction of quaternary ammonium, solvolysis, or derivatization of amide groups into amidine groups

7. A method according to claim 1, wherein said substrate comprises a cellulosic material.

8. A method according to claim 1, wherein said substrate comprises a thermoplastic fluorinated polymer.

9. A method according to wherein said different labels include luminescent molecules.

10. A method according to 1, wherein said different labels are selected from the group consisting of magnetic beads, radioactive isotopes, enzymes, calorimetric molecules and micro-bubbles.

11. The use of a polymer substrate in a method for performing a microarray assay comprising contacting one or more sample fluid with a substrate, wherein said method permits the simultaneous analysis, in one microarray, of one or more types of target biological compounds, in one or more sample fluids wherein at least one of the number of types of target biological compounds and the number of sample fluids is at least 2.
